(19) United States
(12) Patent Application Publication
(10) Pub. No.: US 2019/0185632 A1
(43) Pub. Date: Jun. 20, 2019

(54) CARBON NANOTUBE FILM STRUCTURE AND METHOD FOR MAKING

(71) Applicant: GENERAL NANO LLC, Cincinnati, OH (US)

(72) Inventor: Larry Allen CHRISTY, Cincinnati, OH (US)

(21) Appl. No.: 16/323,001

(22) PCT Filed: Aug. 4, 2017
(86) PCT No.: PCT/US2017/045422

§ 371 Date: Feb. 4, 2019

Related U.S. Application Data
(60) Provisional application No. 62/370,712, filed on Aug. 4, 2016.

(51) Int. Cl. C08J 5/18; C01B 32/174; C08J 3/205; C08K 3/04; C08K 3/08; C08K 9/02; C08K 7/06; C08K 3/22; C08K 3/38; B29C 41/24

(52) U.S. Cl. CPC C08J 5/18; B29K 2105/162; C08J 3/205; C08K 3/041; C08K 3/08; C08K 9/02; C08K 7/06; C08K 3/04; C08K 3/22; C08K 3/38; B29C 41/24; C01B 2202/02; C01B 2202/06; C08K 2201/011; C08K 2201/001; C08K 2003/0806; C08K 2003/0831; C08K 2003/385; C08K 2003/2227; C08K 2003/2272; C08K 2003/2275; C08K 2003/0893; C08J 2377/00; C08J 2379/08; C08J 2327/16; C08J 2327/18; C08J 2327/20; C08J 2371/10; C08J 2363/00; C08J 2383/04; C08J 2383/08; C08J 2309/02; C08J 2325/10; C08J 2339/04; C01B 32/174

(57) ABSTRACT

A carbon nanotube (CNT)/polymer film or CNT/polymer composite structure containing CNTs, arranged uniformly in a randomly oriented distribution in the polymer matrix. The CNT sheet is manufactured by applying a highly dispersed CNT-polymer-solvent suspension, mixed using ultrasonication, over a carrier, using a coating process, and drying to form the CNT/polymer film. The CNT film is useful in making CNT composite laminates and structures having utility for electro-thermal heating, deicing, shielding for wire & cable, thermal interface pads, energy storage, heat dissipation, conductive composites, antennas, reflectors, and electromagnetic environmental effects (E3), such as lightning strike protection, EMP protection, directed energy protection, and EMI shielding in a variety of form factors such as sheets, roll stocks, and tapes.

### BACKGROUND OF THE INVENTION

This invention relates generally to carbon nanotubes, and more particularly to methods for forming materials and structures from carbon nanotubes.

The exceptional mechanical properties of carbon nanotubes can be used in the development of nanotube-based, high performance structural and multifunctional nanostructural materials and devices. Carbon nanotubes have been made that are nanometers in diameter and several microns in length, and up to several millimeters in length. Strong interactions occur between nanotubes due to the van der Waals forces, which may require good tube dispersion, good tube contact, and high tube loading in materials and structures formed from carbon nanotubes.

Carbon nanotubes have been demonstrated as one of the best nanofiller materials for transforming electrically non-conducting polymers into conductive materials. The electrical conductivity of polymers filled with conductive particles is discussed in terms of the percolation phenomena. At low concentrations, below the percolation threshold, the conductivity remains very close to that of the insulating polymer matrix as the electrons still have to travel through the insulating matrix between the conductive filler particles. When a critical volume fraction of the filler, called the percolation threshold, is reached, the conductivity drastically increases by many orders of magnitude. This coincides with the formation of conductive pathways of the filler material forming a three dimensional network, which span the macroscopic sample. The electrons can now predominantly travel along the filler and move directly from one filler to another. Increasing the amount of filler material further, levels off the conductivity, the maximum conductivity of the composite or the film.

There is considerable variability in the percolation threshold values reported for polymer/carbon nanotube composites as it is strongly influenced by several factors such as dispersion, aspect ratio, purity and alignment of the CNTs. Dispersion is probably the most fundamental issue, due to the strong van der Waals interactions between the nanotubes bundles them together. These interactions are notably larger than the polymer-polymer interactions and have been found to be ˜0.5 eV/nm. The CNT films can be produced by a multiple-step process of dispersing nanotubes into a solvent (organic solvents such as DFM, Toluene, MEK, or can be aqueous). The dispersion of CNT can be done using sonication, or high shear mixing. The polymeric composition preferably comprises a thermoplastic, such as polyethylene, polypropylene, PET, PC, and PVDF, or thermosets such as polyimide, polyurethane, and epoxy, or phenolic elastomer, such as polyurethane rubber and silicon rubber.

In general, the main requirements for the nanotubes to provide effective reinforcement in the composite are: good dispersion, interfacial stress transfer, large aspect ratio, and alignment. In these techniques, a well-dispersed nanotube suspension is first prepared, optionally with the aid of selected organic solvent and mixed using high shear mixing and/or sonication. Then, added polymer with desired weight percent (wt %) ratio. The CNT film is formed on a nonporous sheet material such as Teflon coated glass fiber or Teflon coated Kevlar. CNT-polymer suspension can be applied onto a flexible carrier material heated to dry, using a process selected from the group consisting of a solvent cast coating process, a dip process, and a spray coating process. After solvent evaporation, the produced nanotube film can be peeled off from the carrier material.

Many applications, such as electrical conducting, thermal conducting and high performance nanocomposites, are made by pre-forming nanotubes into a network or membrane (5-200 μm in thickness) with controlled nanostructures (density, porosity, dispersion, alignment, and loading). These membranes would also make nanotube materials and their properties capable of transfer into a macroscale material for easy handling. These nanotube networks, formed by filtration, are called buckypapers or CNT nonwovens in the literature. Buckypapers are produced by a multiple-step process of dispersing nanotubes into a suspension and filtering the produced suspension. The produced CNT nonwovens can be easily handled similar to conventional surface veil, carbon fiber, or glass materials. These CNT nonwovens are porous which lend to applications that required impregnation, such as integration into carbon fiber reinforced polymer (CFRP) composites. However, these CNT nonwovens have poor tensile strength limiting some applications such as shield tape for wire and cable. Also, electrical properties of CNT nonwovens can only be tailored to a narrow degree. A CNT/polymer composite allows for both electrical and mechanical tailorability far exceeding CNT nonwovens, giving engineers more room for design. In some cases, increased conductivity has been observed over CNT nonwovens for a given CNT loading, when using very high aspect ratio CNTs (>2500).

Current discontinuous or batch techniques can only produce CNT/polymer films by coating a substrate with a nanotube-polymer suspension or casting into a mold; the dimensions are limited by the substrate size of the mold size. In these techniques, a nanotube-polymer suspension is first prepared, optionally with the aid of selected surfactant and mixed using high shear mixing and/or sonication. Then, the suspension is either cast or a substrate is dip coated and dried, forming a CNT/polymer film.

There are existent technologies that exist to produce solvent cast films, such as slot-die coating, knife or blade coating, gravure coating, roll coating, slide coating, and other processes such as curtain coating, extrusion, dip coating, and spray coating to produce polymer films. For example, a NMP/PVDF film is used to manufacture battery electrodes. Activated carbon is used in these polymer films to act as an electrical conductor to the base metal foil; the activated carbon is mixed into the PVDF-solvent slurry using shear mixers, planetary mixers, and/or other mechanical mixers. High aspect ratio carbon nanotubes (>2500) and ultra high aspect ratio CNTs (approaching 100,000 or more) cannot be adequately dispersed using such methods. Sonication is required to introduce enough energy to the CNT bundles to achieve a high dispersion quality in a given liquid.

Notwithstanding, there remains a need for a process that manufactures CNT films on an industrial and commercial scale in order to meet the emerging technological and market needs for such structures.

### SUMMARY OF THE INVENTION

Methods and devices are provided herein for the continuous production of carbon nanotube-polymer films and other CNT composite structures.

The present invention includes a process for forming CNT-polymer film structures that includes coating a volume of a solution comprising a dispersion of CNTs and polymer and solvent, over a carrier material to provide a layer of a CNT-polymer solution having a uniform dispersion of the CNTs, and a step of drying the coated CNT-polymer solution, to remove solvent, into a CNT film. CNTs can include single wall CNTs (SWCNTs) or multi-wall CNTs (MWCNTs). The SWCNTs can have a median length of at least 5 microns and an aspect ratio of at least 2,500:1, and MWCNTs can have a median length of at least 50 microns and an aspect ratio of at least 2,500:1

The present invention includes a process for manufacturing a carbon nanotube-polymer film, comprising the steps of: i) dispersing carbon nanotubes (CNTs) and polymer into a solvent using high power sonication; ii) applying the suspension of carbon nanotubes (CNTs) onto a continuous, moving, carrier material (which can act as a release liner); iii) evaporating the solvent from the applied CNT suspension to form a CNT/polymer film over the carrier material; and iv) optionally, removing the resulting CNT sheet from the carrier material.

The present invention further includes a continuous process for manufacturing a continuous composite CNT structure, comprising the steps of: i) dispersing carbon nanotubes (CNTs) and polymer into a solvent using high power sonication; ii) applying the suspension of carbon nanotubes (CNTs) onto a continuous, moving, porous substrate material; iii) evaporating the solvent from the applied CNT suspension to form a CNT/polymer-substrate composite over the carrier material; and iv) optionally, removing the CNT sheet from the carrier material.

The present invention further includes a continuous process for manufacturing continuous CNT sheets, comprising the steps of i) dispersing carbon nanotubes (CNTs) and polymer into a solvent using high power sonication; ii) applying the suspension of carbon nanotubes (CNTs) onto a continuous, moving, porous substrate material; iii) evaporating the solvent from the applied CNT suspension to form an entangled CNT-substrate structure wherein the porous substrate can be entirely encapsulated by the CNT/polymer suspension upon drying.

The invention also includes a process for manufacturing a carbon nanotube (CNT)-polymer film with filler material, comprising the steps of: i) dispersing carbon nanotubes (CNTs) and polymer into a solvent using high power sonication, with the addition of a filler material to form a CNT suspension; ii) applying the CNT suspension onto a continuous, moving, carrier material (which can act as a release liner); iii) evaporating the liquid from the applied CNT suspension to form a filled CNT/polymer film structure over the carrier material; and iv) optionally, removing the filled CNT/polymer film structure sheet from the carrier material to form the CNT-polymer film with filler material.

PCT Publication WO 2016/019143 (General Nano LLC), published Feb. 4, 2016 and incorporated herein by reference describes the manufacturing of CNT sheet structures by applying a CNT suspension over a filter material and drawing the dispersing liquid through the filter material to provide a CNT sheet. The CNT sheet can be formed over a porous substrate and/or carrier sheet, which can remain with the CNT sheet as a laminate or composite layer, or can be separated from the CNT sheet after formation of the CNT structure.

In an aspect of the invention, the continuous carrier material is a continuous film, sheet, or fabric material that is essentially non-porous to the CNT suspension. The continuous carrier material provides a stable and resilient structure for pulling the coated CNT-polymer suspension through and along during manufacture and drying of the CNT-polymer film. The continuous carrier material can include coated or uncoated nonwoven, woven, or polymer film. This can include hydrophobic polymers, including but not limited to polytetrafluoroethylene (PTFE), also known as Teflon®, and hydrophilic polymers, including but not limited to aliphatic polyamides, also known as nylon or PET. Other carriers include metal foils such as copper, aluminum, and stainless steel. A carrier with a surface treatment, such as siliconized PET, can be chosen to aid in release of the CNT-polymer film.

In an aspect of the invention, the continuous porous substrate material is a continuous porous film, sheet, or fabric material. A metal-coated woven or a metallic mesh or expanded foil or screen material can also be used as a porous substrate material. Other example carriers include carbon fiber nonwoven, polyester nonwoven, polyester woven, fiberglass nonwoven, and PEEK nonwoven.

The CNT-polymer dispersion can be coated upon the porous substrate material, forming a CNT-substrate composite material.

In another aspect of the invention a continuous roll of metallic wires or fibers, from a plurality of spools or rovings, can be pulled across the width of carrier material in the machine direction. The CNT-polymer dispersion can then be coated upon the aligned or unidirectional metallic wires, forming a CNT-metallic wire composite rollstock material. This process is similar to a pultrusion process, but using the CNT dispersion to encapsulate the fibers instead of a resin. Non-limiting examples of a pultrusion process are disclosed in US Patent Publication US 2011/0306718 and U.S. Pat. No. 5,084,222, the disclosures of which are incorporated by reference in their entireties.

In a further aspect of the invention, a secondary CNT-polymer film layer can be applied to an upper side of a resulting dried CNT film or structure on a carrier. The secondary layer can be used to build up the thickness of the CNT film or structure above the limitations of the primary coater or can add a functionally such insulation to the first CNT film or structure layer. A third, fourth, or more coating can be applied to a desired film thickness or functionally-designed stack structure. For example, alternating conductive and nonconductive film layers which when built up offer a thin structure with very high electromagnetic shielding properties. Another example would be building up a film structure with alternating n-doped and p-doped semi-conducting layers to

In another aspect of the invention the dried CNT-polymer films or CNT-substrate composites can be metallized to further improve electrical conductivity. The metal applying process can be a batch treatment process or a continuous process, selected from the group consisting of sputtering, physical vapor deposition, pulsed laser deposition, electron beam, chemical vapor deposition, electro-chemical (electroplating), and electroless coating.

The manufactured CNT film has a relative density (relative to water) of about 1.5 or less.

The relative density of the manufactured CNT-polymer structure can be about 1.0 or less, and can be about 0.8 or less, about 0.7 or less, about 0.6 or less, about 0.5 or less, about 0.4 or less, and about 0.3 or less, such as 0.25.

In a further aspect of the invention, the CNTs can be chemically treated prior to dispersion to modify the physical or functional properties of the CNTs, or of the CNT film or structure made therefrom.

In another aspect of the invention, the CNTs can be pre-treated by immersion into an acidic solution, including an organic or inorganic acid, and having a solution pH of less than 1.0. A non-limiting example of an acid is nitric acid. Alternatively, or in addition, the CNT film can be post-treated with an acid solution to functionalize or roughen the film surface.

In another aspect of the invention, a filler can be added to a CNT suspension to add functionality to a resulting CNT film or structure. This can include, but not be limited to, adding conductive and/or non-conductive fillers such as carbon nanofiber, graphene, glass fiber, carbon fiber, thermoplastic fiber, thermoset fiber, glass microbubbles, glass powder, thermoplastic powder, thermoset powder, nickel nanowire, nickel nanostrands, chopped nickel coated carbon fiber, ceramic powder, ceramic fiber, or mixtures thereof. For example, nickel nanostrands can be added to the formed CNT structure to increase electrical conductivity and permeability. These properties can increase EMI shielding properties. Another example includes adding multi-lobal polyimide fiber to the CNT nonwoven to improve mechanical properties in a carbon fiber composite system and adding multifunctionality to said composite system.

In another aspect of the invention, the CNTs nonwoven structure can include a plurality of distinctly formed CNT sheets, stacked or laminated together. The stacked layers can also include filler or additive materials. Example filler materials include, but are not limited to, carbon nanofiber, graphene, glass fiber, carbon fiber, thermoplastic fiber, thermoset fiber, glass microbubbles, glass powder, thermoplastic powder, thermoset powder, nickel nanowire, nickel nanostrands, or mixtures thereof. For example, a solution containing graphene can be laid onto and coupled to a previously formed CNT nonwoven layer using the herein mentioned continuous manufacturing process.

### BRIEF DESCRIPTION OF THE FIGURES

FIG. 1 illustrates a process for making a solution containing dispersed CNTs and passing a porous substrate under or through the CNT solution to form a CNT/polymer film structure.

FIG. 2 illustrates an alternative process for forming a CNT/polymer film structure.

FIG. 3 illustrates an alternative process for forming a porous CNT-substrate composite having porosity.

### DETAILED DESCRIPTION OF THE INVENTION

As used herein, the terms “comprise,” “comprising,” “include,” and “including” are intended to be open, non-limiting terms, unless the contrary is expressly indicated.

As used herein, a “free-standing” sheet or structure of CNTs is one that is capable of formation, or separation from a carrier material, and handling or manipulation without falling apart.

A “continuous” sheet of material is an elongated material having a length that is orders of magnitude greater than the width of the material, and a roll of the material.

A process for forming CNT structures of the present invention is an improvement on the conventional process for conductive polymer films and a process that is continuous and scalable. A process for forming CNT structures includes a step or stage of forming a suspension of highly dispersed CNTs in a solvent, coating a volume of the CNT suspension to provide a uniform wet layer of CNT suspension over carrier material, and drying the solvent from the CNT suspension, forming a CNT film or structure.

### Making the Suspension

The first step in making a continuous length of CNT film structure involves making a suspension of CNTs in a liquid, which can include water and/or organic solvent. Optionally, a polymer material can be added to the suspension. The liquid can also include one or more compounds for improving and stabilizing the dispersion and suspension of the CNTs in said liquid, and one or more compounds that improve the functional properties of the CNT structure produced by the method.

While water is the preferred dispersive liquid at scale, other non-solvating liquids can be used to disperse and process the CNTs. As used herein, the term “non-solvating” refers to compounds in liquid form that are non-reactive essentially with the CNTs and in which the CNTs are essentially insoluble. Examples of other suitable non-solvating liquids include volatile organic liquids, selected from the group consisting of acetone, ethanol, methanol, isopropanol, n-hexane, ether, acetonitrile, chloroform, DMF, THF (tetrahydrofuran), NMP (N-Methyl-2-pyrrolidone), MEK (methyl ethyl ketone), DMAC, and mixtures thereof. Low-boiling point solvents are typically preferred so that the solvent can be easily and quickly removed, facilitating drying of the resulting CNT structure.

The dispersive liquid can optionally include one or more surfactants (e.g., dispersant agents, anti-flocculants) to aid forming or to maintain the dispersing, wet-laid formation, or dewatering of the CNTs and wet-laid CNT structures. For example, BYK-9076 (from BYK Chem USA), Triton X-100, dodecylbenzenesulfonic acid sodium salt (NaDDBS), and SDS may be used.

The carbon nanotubes can be provided in a dry, bulk form. The CNTs can include entanglable CNTs that typically have a median length selected from the group consisting of at least about 0.05 mm (50 microns), such as at least about 0.1 mm (100 microns), at least about 0.2 mm, at least about 0.3 mm, at least about 0.4 mm, at least about 0.5 mm, at least about 1 mm, at least about 2 mm, and at least about 5 mm. The CNTs can be said entanglable single wall nanotubes (SWNT), and said entanglable multi-wall nanotubes (MWNT). Typical SWCNTs have a tube diameter of about 1 to 2 nanometers. Typical MWCNTs have a tube diameter of about 5 to 10 nanometers. Examples of MWCNTs useful in the present invention are those disclosed in or made by a process described in U.S. Pat. No. 8,753,602, the disclosure of which is incorporated by reference in its entirety. Such carbon nanotubes can include long, vertically-aligned CNTs, which are commercially available from General Nano LLC (Cincinnati, Ohio, USA). U.S. Pat. No. 8,137,653, the disclosure of which is incorporated by reference in its entirety, discloses a method of producing carbon nanotubes, and substantially single-wall CNTs, comprising, in a reaction chamber, evaporating a partially melted catalyst electrode by an electrical arc discharge, condensing the evaporated catalyst vapors to form nanoparticles comprising the catalyst, and decomposing gaseous hydrocarbons in the presence of the nanoparticles to form carbon nanotubes on the surface of the catalyst nanoparticles.

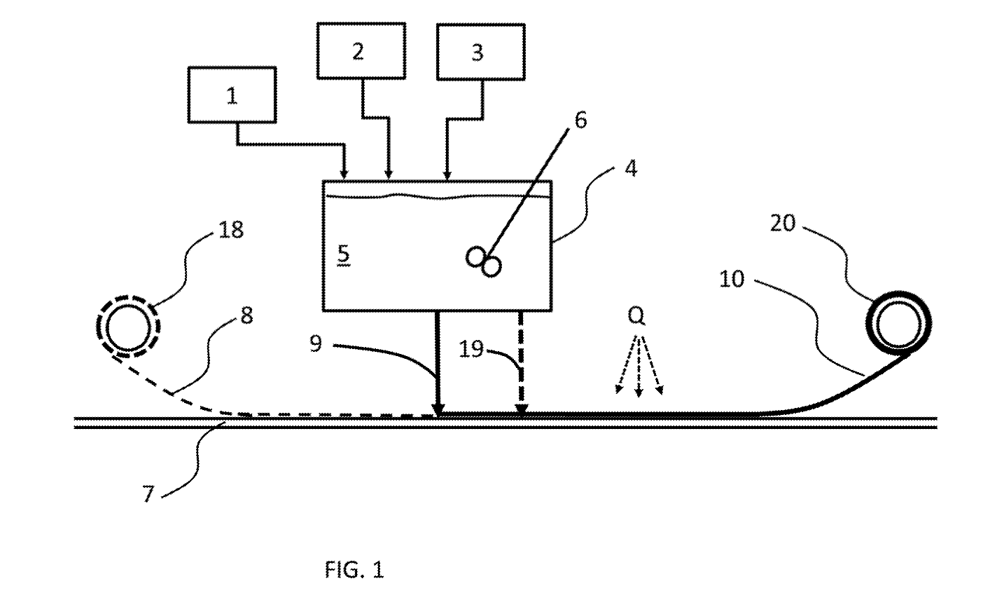

FIG. 1 illustrates a non-limiting process for making a solution containing CNTs. A supply of CNTs (1) is mixed into a solution (5) in a suitable container (4). The solution can include a solvent (2) and a polymer material (3). The CNTs are dispersed into the solution (5) using a suitable mixer (6).

A CNT concentration in the aqueous liquid is at least 1 mg/L of suspension, and up to about 10 g/L, which facilitates dispersion and suspension, and minimizes agglomeration or flocculation of the CNTs in the dispersing liquid. In various embodiments of the invention, the CNT concentration is at least about 500 mg/L, and at least about 700 mg/L, and up to about 5 g/L, up to about 1 g/l, and up to about 500 mg/L. Further, the aqueous suspension can comprise a CNT level selected from the group consisting of about 1% CNTs by weight or less, about 0.5% CNTs by weight or less, about 0.1% CNTs by weight or less, about 0.07% CNTs by weight or less, about 0.05% CNTs by weight or less, and including at least about 0.01% CNTs by weight, such as at least about 0.05% CNTs by weight.

Generally, the CNTs are added to a quantity of the dispersive liquid under mixing conditions using one or more agitation or dispersing devices known in the art. The CNT suspension can be made in a batch process or in a continuous process. In one embodiment, the mixture of CNTs in the aqueous liquid is subjected to sonication using conventional sonication equipment. The suspension of CNTs in water can also be formed using high shear mixing, and microfluidic mixing techniques, described in U.S. Pat. No. 8,283,403, the disclosure of which is incorporated by reference in its entirety. A non-limiting example of a high shear mixing device for dispersing CNTs in a liquid is a power injection system, for either batch of in-line (continuous) mixing of CNT powder and the liquid, by injecting the powder into a high-shear rotor/stator mixer, available as SLIM technology from Charles Ross & Sons Company. A non-limiting example of sonication device for dispersing CNTs in a liquid is a sonitrode or sonitrode array, for either batch of in-line (continuous) mixing of CNT powder and the liquid, by injecting the powder into a high-power sonication probe, available as ultrasonic processor technology from Hielscher.

The Power Number, Nₚ, is commonly used as a dimensionless number for mixing. It is defined as:

N=P/(ω³D⁵ρ),

where
P=power input of mixer,
ω=rotational speed of mixer,
D=mixing blade diameter, and
ρ=dispersion density of liquid

To compare mixing scale, we can analogize with the Kolmogorov scale of mixing, λ, to the average length of CNTs, L.

λ=(ν³/ε)^{1/4},

where
ν=kinematic viscosity of dispersion, and
ε=rate of dissipation of turbulence kinetic energy per unit mass.

For entanglable CNTs, ν is much higher (more viscous); thus, λ is larger but scales to slightly less than linearly. But, it requires a lot of energy (to the 4^{th} power) to get to the same post mixing length. Also, note that e should be about linear with P, the power input of mixer.

Without being bound by any particular theory, it is believed that as a result of mixing and dispersing entanglable CNTs in the liquid, the individual CNTs can begin to de-agglomerate from their respective bundles. Typically, the length of CNTs that are provided into the mixing and dispersing process are longer than those of the resulting dispersed CNTs; for example, a median length selected from the group consisting of at least about 0.005 mm, and an aspect ratio of at least 2,500:1. The median length can be at least 0.1 mm, at least about 0.2 mm, at least about 0.3 mm, at least about 0.4 mm, at least about 0.5 mm, at least about 1 mm, at least about 2 mm, and at least about 5 mm. The median length of the CNTs can also comprise a range selected from the group consisting of between 1 mm and 2 mm, between 1 mm and 3 mm, and between 2 mm and 3 mm. The aspect ratio can be at least 5,000:1, at least 10,000:1, at least 50,000:1, and at least 100,000:1,

The resulting suspension of CNTs in the liquid is stable for at least several days, and longer. The suspension of CNTs can be mixed and stirred prior to use in the film coating process in order to ensure homogeneity of the CNT dispersion.

The dispersive liquid can also optionally include one or more filler or functional filler materials. A functional filler material can be one that has properties that may modulate the properties of the CNT sheet or structure that is produced by the process described herein. Such function fillers (or properties) can include non-magnetic dielectric materials, magnetic dielectric materials, electrically non-conductive materials, electrically conductive materials. The materials can include particles, agglomerates, fibers, and others. Examples of non-magnetic dielectric materials include epoxies, polyamides, and polyimides. Examples of magnetic dielectric materials include ferrite, ferrite-filled epoxy, ferrite-filled polyimide, and ferrite-filled polyamide. Examples of electrically non-conductive materials include thermoplastic or thermoset materials, including without limitation, polyamide, polyimide, round or multi-lobal thermoplastic fibers, and polyamide and polyimide thermoset powder. Other examples of electrically non-conductive materials include ceramic fibers, including by example alumina, boron nitride, ceramic powder, including by example alumina boron nitride, ferrites including Fe₂O₃ and Fe₃O₄, MnZn, NiZn, and nanoparticles including graphene and gold nanoparticles. Examples of electrically conductive materials include metal nanofibers or wire including by example nickel nano-strands and silver nanowire, metalized fibers including by example chopped nickel coated carbon fiber, and nanoparticles including by example graphene and gold nanoparticles.

### Coating and CNT Film Structure Formation

The second step in making the CNT film structure comprises passing a volume of the CNT suspension over a carrier material, applying the CNT-polymer suspension onto a flexible carrier material using a process selected from the group consisting of a solvent cast coating process, a dip coating process, and a spray coating process. The CNT suspension can be heated to drive off the solvent, forming a CNT-polymer film on the carrier layer.

Upon coating, the CNT suspension is evenly distributed over the carrier, wherein the CNT suspension will appear as a uniform, black wet layer across the entire width of the carrier material. Typically the dried CNT film structure has a uniformity of not more than 10% coefficient of variance (COV), wherein COV is determined by a well-known, conventional method.

The carrier material is a flexible, resilient sheet material is essentially nonporous to the CNT suspension selected from a group of metal foils (e.g. copper, aluminum, stainless steel), polymer film (e.g. PET, PET with release surfacing, nonwovens (e.g. cellulose, PET), or coated wovens (e.g. Teflon coated fiberglass).

The desired basis weight of the resulting CNT structure is affected by several parameters, including process conditions, apparatus, and the materials used. Generally, the larger the basis weight required, the higher the required CNT concentration, and/or the larger the dispersed liquid loading, and/or the larger the vacuum zone area, and/or the higher the vacuum applied, and/or the slower the linear speed of the filter material over the vacuum zone. All of these parameters can be manipulated to achieve specific desired characteristics of the CNT nonwoven sheet, including its thickness, density, and porosity.

FIG. 1 also illustrates applying the solution containing CNTs onto a porous substrate. A supply of a porous substrate (8), shown on a continuous roll (18) is passed under or through the CNT solution (9), where the CNTs are deposited onto the porous substrate (8) and separated from the liquid of the CNT solution. A porous carrier (7) can be used under the porous substrate (8) passing through the liquid portion of the CNT solution. As source of heat Q can be used to remove residual liquid from the resulting CNT/polymer film structure (10). The CNT/polymer film structure (10) can be collected as a continuous roll 20. An additional quantity of CNT solution (19) can be provided to form a second or additional layer of CNT structure.

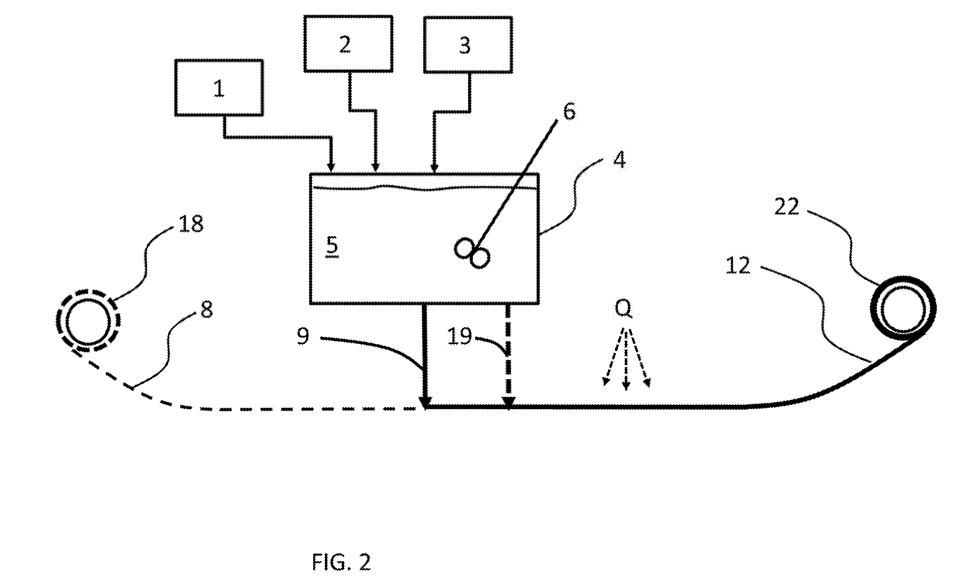

In an alternative process illustrated in FIG. 2, the porous substrate (8) is passed into or through the CNT solution (9), where the CNTs are deposited onto the porous substrate (8) and separated from the liquid of the CNT solution (9), resulting in a CNT/polymer film structure (12) that can be collected as a continuous roll 22.

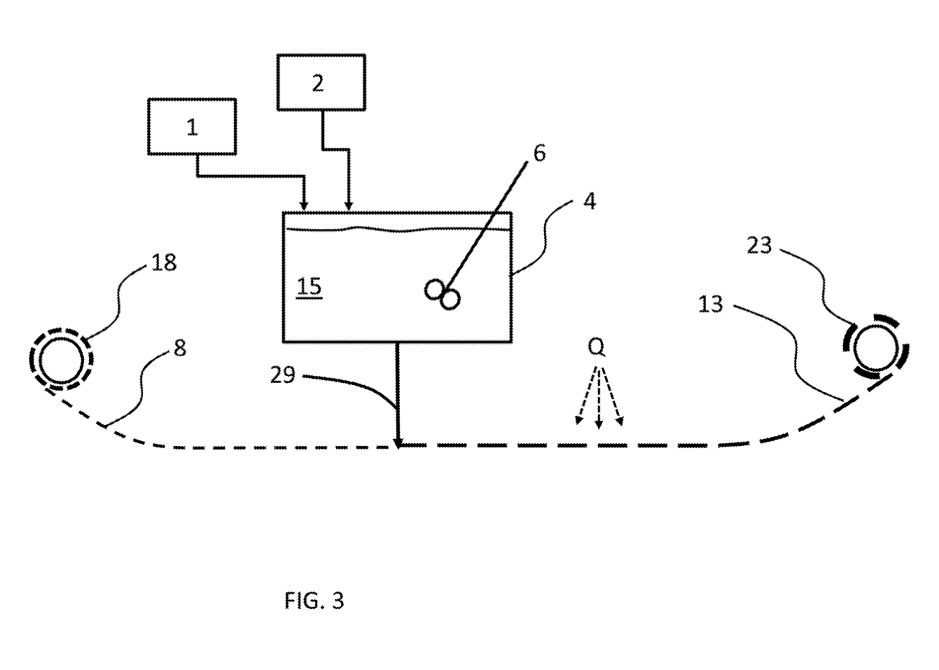

In another process illustrated in FIG. 3, a CNT suspension (15) is formed by mixing CNTs (1) into a solvent (2). A quantity (29) of the CNT suspension (15) is passed over or through a porous substrate (8). After the liquid portion of the CNT suspension is separated, any needed heating is provided to remove residual liquid removal. The resulting porous CNT-substrate composite (13) has a porosity that is substantially the same as the flexible porous substrate (8), and can be collected on a roll (23).

### CNT Films and CNT Composite Structures

The CNT film or CNT composites made according to the present invention, when used alone or as part of a composite structure or laminate, can provide numerous mechanical and functional benefits and properties, including electrical properties. The CNT films and composite laminates and structures thereof can be used for constructing long and continuous thermal and electrical paths using CNTs in large structures or devices. The CNT films and composites and structures thereof can be used in a very wide variety of products and technologies, including aerospace, communications, and power wire and cable, wind energy apparatus, sporting goods, etc. The CNT film and composites and structures thereof are useful as light-weight multifunctional composite structures that have high strength and electrical conductivity. The CNT film sheets and composites and structures thereof can be provided in roll stock of any desirable and commercially-useful width, which can integrate into most conventional product manufacturing systems.

Non-limiting examples of functional properties, and the modulation thereof, that can be provided by the CNT film and composites and structures thereof, are electro-thermal heating, deicing, shielding for wire & cable, thermal interface pads, energy storage, heat dissipation, conductive composites, antennas, reflectors, and electromagnetic environmental effects (E3), such as lightning strike protection, EMP protection, directed energy protection, and EMI shielding in a variety of form factors such as sheets, rollstocks, and tapes.

### Functionalizing of CNTs

Functional properties of a CNT nonwoven sheet can be affected by treatment of the CNTs, prior to their dispersion and suspension. The treatment of the CNTs can include a chemical treatment or a mechanical treatment.

In one aspect of the invention, functional properties of CNTs can be affected by an acid treatment of the CNTs, prior to their dispersion and suspension. An acid treatment is believed to improve CNT purity and quality, by reducing the level of amorphous carbon and other defects in the CNTs. Treatment of the bulk CNT powder with strong (nitric) acid can cause end-cap cutting, and the introduction of carboxyl groups to the CNT sidewall. The addition of carboxyl groups to the CNT sidewalls can also enhance dispersion of the CNTs in water or other polar solvent by increasing the hydrophilicity of the CNTs. The removal of amorphous carbon coatings on individual nanotubes increases the concentration of crosslink joints and higher bending modulus, which can create more conductive tunnels and connections. CNT end-cap cutting can improve electrical conductivity by improving electron mobility from the ends of the carbon nanotubes to adjacent carbon nanotubes (tunneling). Likewise, post-formation acid treatment can improve electrical conductivity and increase the structure's density.

The acid treatment of the CNTs enhances CNT interactions and charge-carrying and transport capabilities. Acid treatment of the CNTs can also enhance cross-linking with a polymer composite. Without being bound by any particular theory, it is believed that during acid oxidation, the carbon-carbon bonded network of the graphitic layers is broken, allowing the introduction of oxygen units in the form of carboxyl, phenolic and lactone groups, which have been extensively exploited for further chemical functionalization.

The pre-treatment of the CNTs can include immersing the CNTs into an acidic solution. The acid solution can be a concentrated or fuming solution. The acid can be selected from an organic acid or inorganic acid, and can include an acid that provides a solution pH of less than 1.0. Examples of an acid are nitric acid, sulfuric acid, and mixtures or combinations thereof. In an embodiment of the invention, the acid is a 3:1 (mass) ratio of nitric and sulfuric acid.

Alternatively or in addition to acid post-post treatment, the CNT powder or formed CNT sheet or structure can be functionalized with low pressure/atmospheric pressure plasma, as described in Nanotube Superfiber Materials, Chapter 13, Malik et al, (2014), the disclosure of which is incorporated by reference in its entirety. A Surfx Atomflo 400-D reactor employing oxygen and helium as the active and carrier gases, respectively, provides a suitable bench-scale device for plasma functionalizing CNTs and CNT sheet or structure. An alternative plasma device can include a linear plasma head for continuous functionalization of CNT sheet or structure, including a roll stock. An atmospheric plasma device produces an oxygen plasma stream at low temperature, which minimizes or prevents damage to the CNTs and the CNT structures. In an example, a plasma is formed by feeding He at a constant flow rate of 30 L/min and the flow rate of 0₂ (0.2-0.65 L/min) is adjusted as per the plasma power desired. Structural and chemical modifications induced by plasma treatments on the CNTs can be tailored to promote adhesion or to modify other mechanical or electrical properties. Additionally, plasma functionalization can be used to clean the surface of the CNT film or structure, cross-link surface molecules, or even generate other polar groups on the surface to which additional functional groups can be attached. The extent to which the CNT film or structure are affected by plasma functionalization can be characterized using Raman spectroscopy, XPS, FTIR spectroscopy and changes in hydrophobic character of the CNT material through contact angle testing.

1. A process for manufacturing a carbon nanotube (CNT)/polymer film structure, comprising the steps of:
i) mixing carbon nanotubes (CNTs), a polymer, and a solvent, using sonication, to form a CNT-polymer suspension;
ii) applying the CNT-polymer suspension onto a flexible carrier using a process selected from the group consisting of a solvent cast coating process, a dip coating process, and a spray coating process;
iii) applying heat to said applied CNT-polymer suspension and flexible carrier to remove the solvent, to leave a CNT-polymer film over the flexible carrier and form a CNT/polymer film structure; and
iv) optionally removing the CNT-polymer film structure from the flexible carrier.

2. The process according to claim 1, wherein the flexible carrier is nonporous and is unrolled or extruded continuously.

3. The process according to claim 2, wherein the flexible carrier is selected from the group consisting of
i) a metal foil, typically a copper, aluminum, stainless steel foil,
ii) a polymer film, typically PET, PET having a release surfacing, a nonwoven fabric, for example, a cellulose or a PET, and a coated woven fabric, for example a Teflon-coated fiberglass.

4.-5. (canceled)

6. The process according to claim 2, wherein the CNT-polymer film structure is a continuous elongated structure.

7. (canceled)

8. The process according to claim 1, wherein the polymer is dissolved in the solvent at a concentration up to the limit of solubility in the solvent.

9. The process according to claim 8, wherein the step of mixing is selected from the group consisting of mixing with a high shear mixer, sonicating, or a combination thereof, to disperse the CNTs in the solvent.

10. The process according to claim 9, wherein the CNTs are first mixed and dispersed in the solvent, and then the polymer is mixed into to the CNT-solvent dispersion.

11. The process according to claim 1, wherein the CNTs are selected from the group consisting of single wall CNTs (SWCNTs), multi wall CNTs (MWCNTs), and a mixture thereof.

12. (canceled)

13. The process according to claim 1, wherein the polymer is selected for the group consisting of a powder, a resin, and a fiber, and the polymer material is selected from the group consisting of:
a. a thermoplastic material, selected from the group consisting of polyamide, PVDF, PEI, PEEK, FEP, and PTFE, and combinations thereof;
b. a thermoset material, selected from the group consisting of polyimide, epoxy, and BMI, and combinations thereof;
c. an elastomer material, selected from the group consisting of silicone, nitrile rubber, fluorosilicone, and styrene-butadiene, and combinations thereof; and
d. a combination thereof.

14. The process according to claim 13, wherein the CNTs are dispersed in an organic solvent, selected from the group consisting of N-methyl-2-pyrrolidone (NMP), dimethylformamide (DMF), dimethylacetamide (DMAC), acetone, isopropanol, tetrahydrofuran (THF), and methyl ethyl ketone (MEK), and mixtures thereof.

15. The process according to claim 14, wherein the solvent includes water, and the CNT suspension optionally further includes a mixing aid material comprising a surfactant.

16. The process according to claim 15, wherein the CNTs are dispersed in an acidic solution, the acid selected from the group consisting of sulfuric acid, nitric acid, and chlorosulfonic acid.

17. The process according to claim 15, wherein the CNTs are dispersed in a basic solution, the base comprising sodium hydroxide.

18. The process according to claim 1, wherein the polymer is a thermoplastic or a thermoset resin, and where the solvent dilutes the polymer sufficiently to disperse the CNTs.

19. The process according to claim 1 where the processing provides a randomly oriented, uniformly distributed CNT structure.

20. The process according to claim 1, where the step of applying the CNT suspension imparts a degree of alignment of the CNTs.

21.-22. (canceled)

23. The process according to claim 22, wherein the CNT suspension includes a conductive filler material or additive, and is selected from the group consisting of:
i.) metal nanofibers or wire selected from the group consisting of nickel nano-strands and silver nanowire;
ii.) metalized fibers selected from the group consisting of chopped nickel-coated carbon fiber; and
iii.) nanoparticles selected from the group consisting of graphene and gold nanoparticles.

24. The process according to claim 22, wherein the CNT suspension includes a non-conductive filler material or additive, and is selected from the group consisting of:
i.) thermoplastic or thermoset fibers selected from the group consisting of polyamide and polyimide (round or multi-lobal);
ii.) thermoplastic or thermoset powder selected from the group consisting of polyamide and polyimide;
iii.) ceramic fibers selected from the group consisting of alumina and boron nitride;
iv.) ceramic particles or powder selected from the group consisting of alumina, boron nitride, ferrites, Fe2O3, Fe3O4, MnZn, and NiZn;
v.) nanoparticles; and
vi.) combinations thereof.

25.-27. (canceled)

28. The process according to claim 1 wherein the step of applying the CNT suspension is a batch treatment process or a continuous process.

29.-78. (canceled)
